(19) United States
(12) Patent Application Publication
(10) Pub. No.: US 2012/0171942 A1
(43) Pub. Date: Jul. 5, 2012

(54) VENTILATION NOZZLE FOR A MOTOR VEHICLE

(75) Inventor: Axel HERZER, Woerrstadt (DE)

(73) Assignee: GM GLOBAL TECHNOLOGY OPERATIONS LLC, Detroit, MI (US)

(21) Appl. No.: 13/337,515

(22) Filed: Dec. 27, 2011

(30) Foreign Application Priority Data
Dec. 28, 2010 (DE) 102010056398.6

(51) Int. Cl. B60H 1/34; B60H 1/24

(52) U.S. Cl. 454/152

(57) ABSTRACT

A ventilation nozzle is provided for a motor vehicle, the ventilation nozzle includes, but is not limited to an outlet. A loudspeaker with a cross section that is reduced relative to the outlet is arranged in the ventilation nozzle.

### CROSS-REFERENCE TO RELATED APPLICATION

This application claims priority to German Patent Application No. 102010056398.6, filed Dec. 28, 2010, which is incorporated herein by reference in its entirety.

### TECHNICAL FIELD

The technical field relates to a ventilation nozzle for a motor vehicle with an outlet.

### BACKGROUND

It is known from practical usage to arrange ventilation nozzles in an interior space of a motor vehicle, which are coupled with ventilation ducts located behind. Furthermore it is know from practical use to install loudspeakers of an audio system in the interior space of motor vehicle.

### SUMMARY

Starting out from the prior art described before, a ventilation nozzle is to be configured in such a manner that in the installed state it comprises a wide function with a construction that is visually unchanged to a beholder. A ventilation nozzle for a motor vehicle comprises an outlet and a loudspeaker with a cross section reduced relative to the outlet and arranged in the ventilation nozzles.

The ventilation nozzles, which is usually installed in an instrumental panel in the interior space of a motor vehicle comprises, in addition to its actual function for the air conditioning or ventilation of the interior space of the motor vehicle, the additional function of accommodating the loudspeaker, which accordingly does not use installation space in the interior of the motor vehicle and furthermore is also not perceptible visually on the instrument panel or any other covering part to the occupant or the beholder. In addition, ventilation nozzles frequently have such installation locations which are also favorable for the arrangement of the loudspeakers. In that the loudspeakers are dimensioned such that they have a cross section that is reduced relative to the outlet both sound and air can emerge from the outlet of the ventilation nozzles, while the appropriate cross sections can be determined by a person skilled in the art using known mathematical methods and/or test setups.

To determine the loudspeaker in a configuration, a cage supporting a diaphragm of the loudspeaker is either an integral component part of a grille covering the outlet or assigned to a holder spaced from the grille. Practically, the cage is fastened centered to the outlet by means of holding spokes. The holding spokes extend between a housing or an outlet grille of the ventilation nozzle and the loudspeaker and center the loudspeaker relative to the outlet so that an even annular gap between the loudspeaker and the ventilation nozzle is available as flow cross section for the air flowing into the interior space of the motor vehicle. The holding spokes can have a geometry that is favorable in terms of flow, for example, the shape of an airfoil of an airplane is provided to create the least interfering noises possible.

For reducing the swirling of the airflow in the ventilation nozzle due to the installed loudspeaker, the loudspeaker is advantageously covered with a pot-shaped cover on the side facing away from the beholder. The cover thus extends in the direction opposite to the outlet and is located within the ventilation nozzles, for example in a corresponding ventilation duct. Preferentially, the cover is configured in the shape of a cone or in the shape of a truncated cone.

According to a further embodiment, the cover is connected to the cage or the holder at the edge. When the cover is coupled to the cage of the loudspeaker the manufacturer of the loudspeaker can perform the arrangement, otherwise the manufacturer of the ventilation nozzle can assemble the cover. Obviously, the cover comprises at least one passage for cables for connecting the loudspeaker to an audio system of the motor vehicle. The cables are installed for example through the ventilation ducts assigned to the ventilation nozzle. Preferably, the loudspeaker extends into a diffuser assigned to the ventilation nozzle.

It is to be understood that the features mentioned above and still to be explained in the following cannot only be used in the respective combination stated but also in other combinations. The scope is only defined by the claims.

### BRIEF DESCRIPTION OF THE DRAWINGS

The present invention will hereinafter be described in conjunction with the following drawing figures, wherein like numerals denote like elements, and:

FIG. 1 is a sectional representation of a ventilation nozzle;

FIG. 2 is a sectional representation of the ventilation nozzle according to FIG. 1 in first embodiment;

FIG. 3 is a sectional representation of the ventilation nozzle according to FIG. 1 in second embodiment;

FIG. 4 is a sectional representation of the ventilation nozzle according to FIG. 1 in third embodiment; and

FIG. 5 is a sectional representation of the ventilation nozzle according to FIG. 3 according to the line V-V.

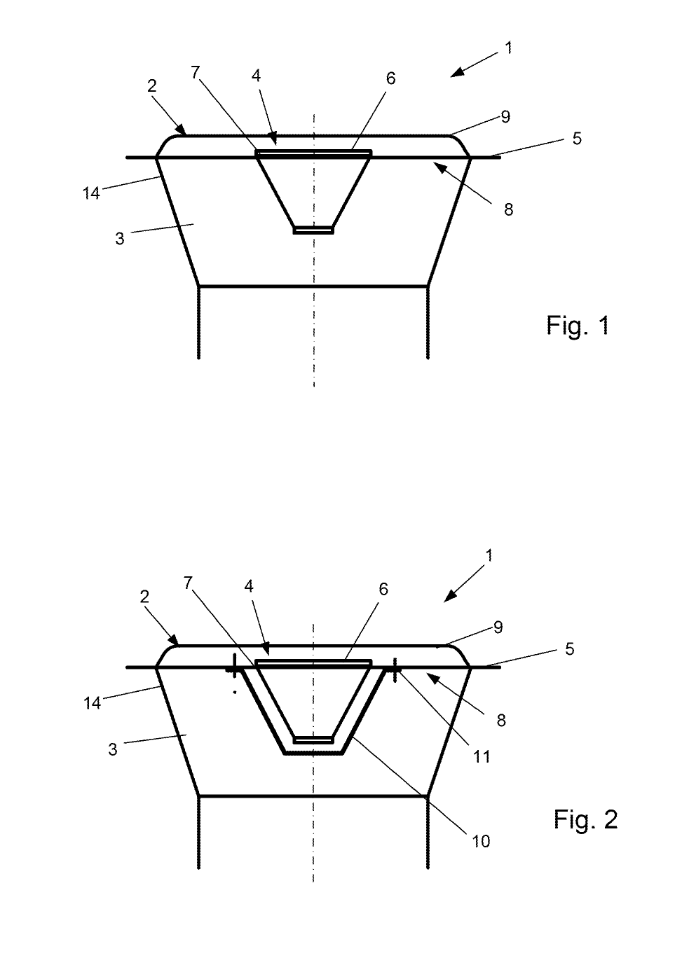

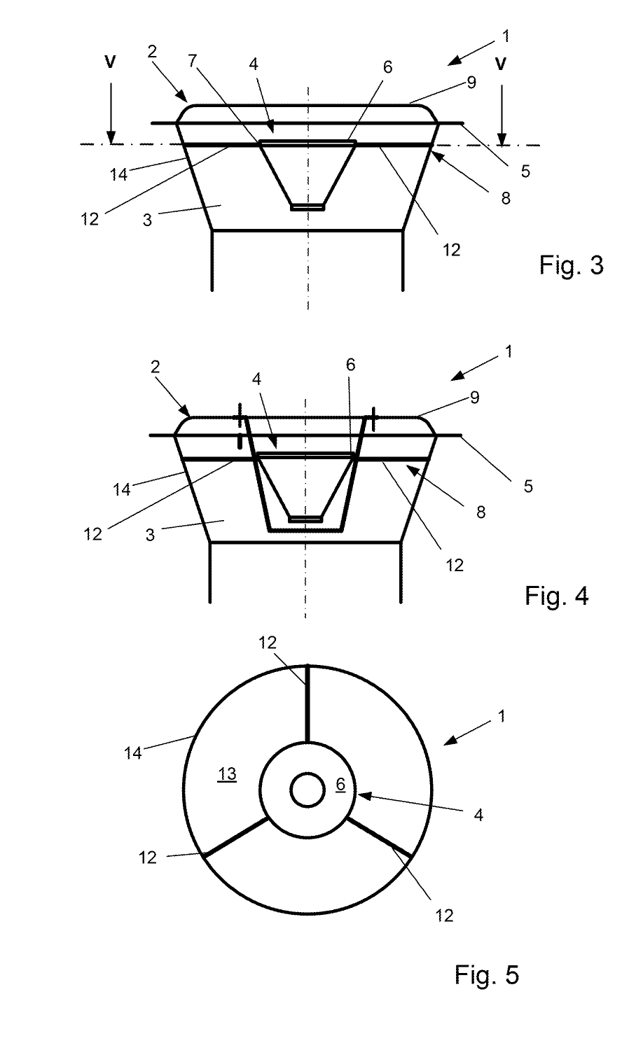

### DETAILED DESCRIPTION

The following detailed description is merely exemplary in nature and is not intended to limit application and uses. Furthermore, there is no intention to be bound by any theory presented in the preceding background or summary or the following detailed description.

The ventilation nozzle 1 is installed in an instrument panel 5 of a motor vehicle and comprises an outlet 2 facing a beholder which is covered with a grille 9, which can serve for the steering of an airflow and comprise adjustable fins. In the ventilation nozzle, a loudspeaker 4 with a cross section that is reduced relative to the outlet 2 is arranged in the region of a diffuser 3. The loudspeaker 4 comprises a cage 7 supporting a diaphragm 6, which is fixed to a holder 8 within the ventilation nozzle 1. The holder 8 is arranged spaced from the grille 9 covering the outlet 2, so that the loudspeaker 4 does not have a visually interfering effect on the side of the grille 9 facing away from the beholder. In order to reduce air swirls, the loudspeaker 4 in an alternative configuration of the ventilation nozzle 1 is inserted in a pot-shaped cover 10, which with its edge 11 is fixed to the holder 8 or the grille 9. For fastening the loudspeaker 4 it is also possible to provide holding spokes 12 evenly distributed over the circumference which extend between a wall 14 of the ventilation nozzle and the cage of the loudspeaker 4 and center the loudspeaker 4 relative to the ventilation nozzle 1 so that an even annular gap 13 for the airflow is available.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A ventilation nozzle for a motor vehicle, comprising:
an outlet; and
a loudspeaker with a cross section that is reduced relative to the outlet and arranged in the ventilation nozzle.

2. The ventilation nozzle according to claim 1, further comprising a cage supporting a diaphragm of the loudspeaker as an integral component part of a grille covering the outlet.

3. The ventilation nozzle according to claim 1, further comprising a cage supporting a diaphragm of the loudspeaker and assigned to a holder spaced from a grille.

4. The ventilation nozzle according to claim 2, wherein the cage is fastened to the outlet centered with a plurality of holding spokes.

5. The ventilation nozzle according to claim 3, wherein the loudspeaker on a side facing away from a beholder is covered with a pot-shaped cover.

6. The ventilation nozzle according to claim 5, wherein the pot-shaped cover is configured in a truncated cone shape.

7. The ventilation nozzle according to claim 5, wherein the pot-shaped cover is configured in a cone shape.

8. The ventilation nozzle according to claim 5, wherein the pot-shaped cover at an edge is connected to the cage.

9. The ventilation nozzle according to claim 5, wherein the pot-shaped cover at an edge is connected to the holder.

10. The ventilation nozzle according to claim 1, wherein the loudspeaker extends into a diffuser assigned to the ventilation nozzle.
